(19) United States
(12) Patent Application Publication
(10) Pub. No.: US 2002/0054747 A1
(43) Pub. Date: May 9, 2002

(54) Fiber handling track for optical equipment

(75) Inventor: Brian M. Foley, Towson, MD (US)

Correspondence Address: Johnny A. Kumar, FOLEY & LARDNER, Washington Harbour, 3000 K Street N.W., Suite 500, Washington, DC, 20007-5109, US

(73) Assignee: Dorsal Networks, Inc.

(21) Appl. No.: 09/960,482

(22) Filed: Sep. 24, 2001

(30) Foreign Application Priority Data
Nov. 9, 2000 (DE) 100 55 455.5

(51) Int. Cl. G02B 6/00

(52) U.S. Cl. 385/134

(57) ABSTRACT

An equipment rack includes a subrack mounted in a first direction and one or more circuit cards, each circuit card being mounted in the subrack in a second direction substantially perpendicular to the first direction and in parallel with each other circuit card mounted in the subrack. Each circuit card includes one or more ports coupled to a respective optical fiber traveling in the second direction. The equipment rack also includes a fiber handling track mounted in the first direction. The fiber handling track includes one or more radius control bosses, the number of radius control bosses equaling or exceeding the number of circuit cards mounted in the subrack. Each of the radius control bosses is adapted to receive an optical fiber coupled to a respective one of the one or more circuit cards and divert the received optical fiber from the second direction to the first direction. The fiber handling track also includes a bell flare located at one end of the fiber handling track, the bell flare adapted to receive the optical fibers diverted by the one or more radius control bosses and divert the received optical fibers from the first direction to a third direction substantially perpendicular to the first direction.

### FIELD OF THE INVENTION

The present invention relates generally to optical communication equipment, and more particularly to a system and method for routing fiber from components in optical communication equipment.

### BACKGROUND OF THE INVENTION

In current optical communication networks, there are multiple signal channels travelling over each optical fiber. Each signal channel is generated by an optical transmitter, which is typically formed on a circuit board. Each transmitter circuit board is mounted in a cabinet with other transmitters or other types of optical communication equipment. The signal channels output from the transmitters are multiplexed together, such as by using wavelength division multiplexing (WDM). The components for multiplexing the signal channels are also typically formed on circuit boards mounted in a cabinet, either independent of or together with the transmitters. To communicate with each other, the circuit boards receive and output optical signals via optical fibers.

As optical communication systems continue to increase their capacity, the amount of signal channels, and correspondingly, the number of transmitter and WDM circuit boards continue to increase as well. This increase in the number of transmitter and WDM circuit boards makes the interconnecting of optical fibers between the boards more complex and difficult to handle. Accordingly, it would be useful to have a device in the cabinet to help control the arrangement of the optical fibers interconnecting the transmitter and WDM boards.

### SUMMARY OF THE INVENTION

Briefly, in one aspect of the invention, an equipment rack includes a subrack mounted in a first direction and one or more circuit cards, each circuit card being mounted in the subrack in a second direction substantially perpendicular to the first direction and in parallel with each other circuit card mounted in the subrack. Each circuit card includes one or more ports coupled to a respective optical fiber traveling in the second direction. The equipment rack also includes a fiber handling track mounted in the first direction. The fiber handling track includes one or more radius control bosses, the number of radius control bosses equaling or exceeding the number of circuit cards mounted in the subrack. Each of the radius control bosses is adapted to receive an optical fiber coupled to a respective one of the one or more circuit cards and divert the received optical fiber from the second direction to the first direction. The fiber handling track also includes a bell flare located at one end of the fiber handling track, the bell flare adapted to receive the optical fibers diverted by the one or more radius control bosses and divert the received optical fibers from the first direction to a third direction substantially perpendicular to the first direction.

In another aspect of the present invention, each of the one or more radius control bosses restricts the bending of the received optical fiber from bending more than a minimum bend radius.

In yet another aspect of the present invention, the bell flare restricts the bending of the received one or more optical fibers from bending more than a minimum bend radius.

### BRIEF DESCRIPTION OF THE DRAWINGS

FIG. 1A is an anterior isometric view of a fiber handling track consistent with the present invention.

FIG. 1B is an posterior isometric view of the fiber handling track of FIG. 1A.

FIG. 1C is a block diagram of a WDM terminal unit consistent with the present invention.

FIG. 2A is a front view of the fiber handling track of FIG. 1A.

FIG. 2B is a back view of the fiber handling track of FIG. 1A.

FIG. 3A is a detail view along the A-section of the fiber handling track of FIG. 2A.

FIG. 3B is a detail view along the B-section of the fiber handling track of FIG. 2A.

FIG. 3C is a plan view of the bell flare of the fiber handling track of FIG. 1A.

FIG. 4 is an isometric view of an equipment rack including the fiber handling track of FIG. 1A.

FIG. 5 is a front view of the equipment rack of FIG. 4.

FIG. 6 is a side view of the equipment rack of FIG. 4.

FIG. 7 is a detail view along the A-section of the equipment rack of FIG. 5.

FIG. 8 is an isometric view of an equipment rack with multiple subracks and fiber handling tracks consistent with the present invention.

### DETAILED DESCRIPTION OF THE PREFERRED EMBODIMENT

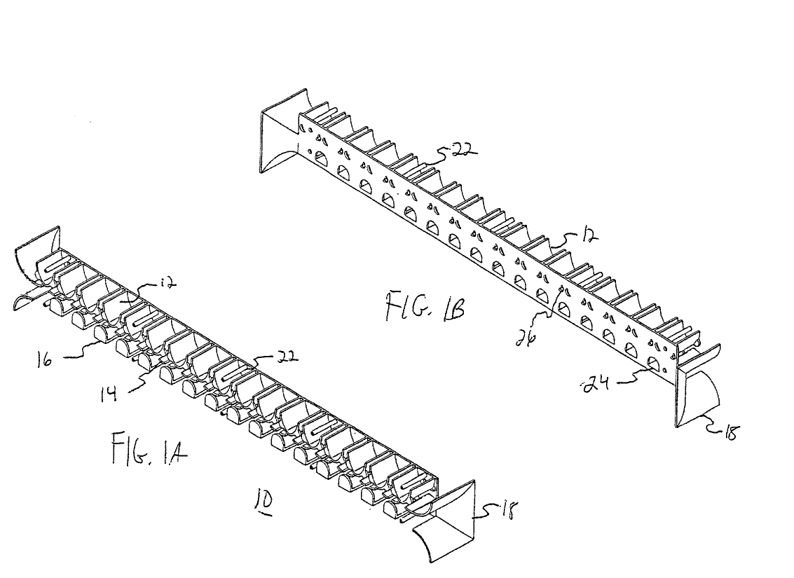

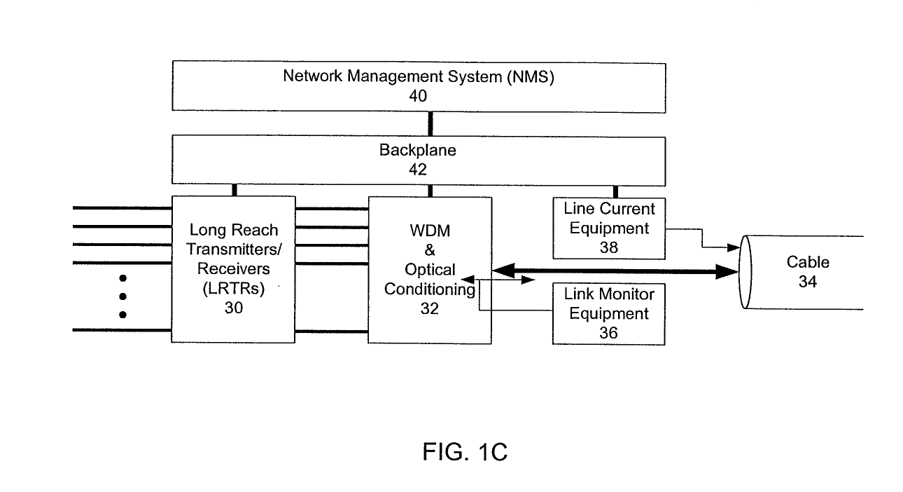

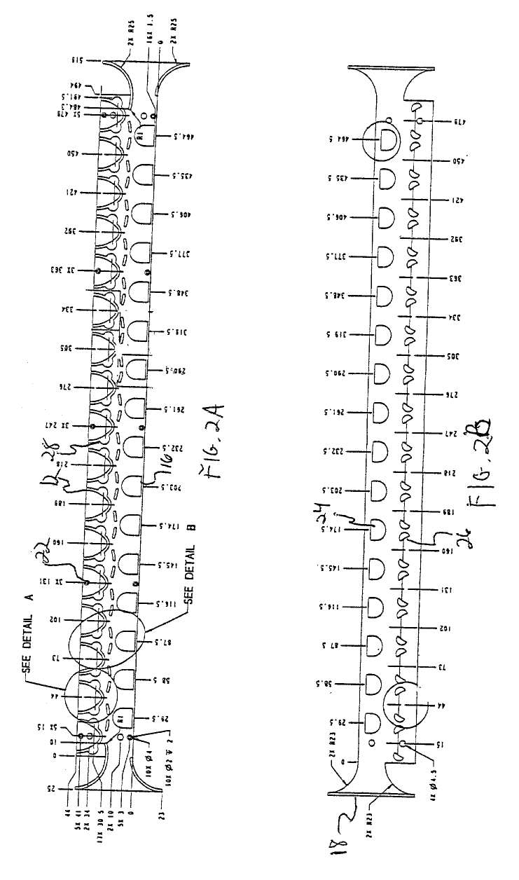

FIG. 1A is an anterior isometric view of a fiber handling track consistent with the present invention. As shown in FIG. 1A, a fiber handling track 10 includes radius control bosses 12, radius control tabs 14, fiber retention tabs 16, bell flares 18, and cover bosses 22. The radius control bosses 12 are arranged along one side of the fiber handling track 10. The radius control bosses 12 are designed to receive one or more optical fibers and divert them in a substantially perpendicular direction. In addition, the radius control bosses 12 are shaped to ensure that the optical fibers do not bend beyond a minimum bend radius, such as approximately 25 mm. The shape can be semi-cylindrical, such as shown in FIG. 1A, or some other shape that restricts the optical fibers from bending beyond the minimum bend radius. The radial control bosses 12 can be fabricated from a material, such as plastic, which is then inserted into the frame of the fiber handling track 10. The fiber handling track 10 can be fabricated from a material such as sheet metal.

A pair of the radius control tabs 14 are placed adjacent to each radius control boss 12 and are located in the approximate middle of the fiber handling track. The radius control tabs 14, like the radius control bosses 12, keep the optical fibers from exceeding the minimum bend radius. The radius control tabs 14 can be flat or have a slight arc that corresponds to the curve of the radius control bosses 12. The radius control tabs 14 also maintain the optical fibers in the direction in which the radius control bosses 12 have diverted them.

The fiber retention tabs 16 are arranged along a side of the fiber handling track 10 opposite the radius control bosses 12. Each fiber retention tab 16 has a flat portion and a tongue portion bent at an approximately 90 degree angle from the flat portion. The fiber retention tabs 16 help keep the optical fibers in the fiber handling track 10 that have been received and diverted by the radius control bosses 12.

The bell flares 18 are located at each end of the fiber handling track 10. As shown in FIG. 1A. The bell flares 18 are designed to receive one or more optical fibers that have been diverted by the radius control bosses 12 and divert them in a substantially perpendicular direction from the direction in which they were received. Like the radius control bosses 12, the bell flares 18 are shaped to ensure that the optical fibers do not bend beyond the minimum bend radius.

As shown in FIG. 1A, each bell flare 18 is a three-sided component, where each side is a similarly shaped flared portion. Each flared portion is curved to divert any received optical fibers in a direction perpendicular to the direction in which the optical fibers were received. Given the three sides, the bell flare 18 can divert the received optical fibers in three different perpendicular directions, but all within substantially the same plane. Although shown with three sides, the bell flare 18 could have as few as one or as many as four or more sides. Alternatively, the bell flare 18 could have a continuous curve or flare and be shaped somewhat like a sloped inverted cone.

The cover bosses 22 are located periodically on each side of the fiber handling track 10. As shown in FIG. 1A, the cover bosses 22 on the side with the radius control bosses 12 are placed within the semi-cylindrical shape of a respective radius control boss 12. The cover bosses 22 on the side with the fiber retention tabs 16 are placed between adjacent pairs of the fiber retention tabs 16. The cover bosses 22 are connectable to a cover plate, not shown, which retains the optical fibers within the fiber handling track 10. The cover bosses 22, as shown in FIG. 1A, are shaped as cylindrical pegs, but could be shaped in any manner that facilitates a connection to the cover plate.

Fig. 1B is an posterior isometric view of the fiber handling track 10. In addition to the components of the fiber handling track 10 shown in FIG. 1A, Fig. 1B shows break through portions 24 and 26. Break through portions 24 provide localized channels, which permit the optical fiber to be routed into or out from the devices to which the fiber handling track 10 is attached, such as individual terminal line cards. Break through portions 26 provide connection points of the radial control bosses 12 to the frame of the fiber handling track 10.

Optical fiber handling tracks 10 consistent with the present invention can be employed in WDM terminal units, which transmit and receive optical signals over a large number of WDM channels. FIG. 1C shows a block diagram of an exemplary architecture for a WDM terminal consistent with the present invention. In the example of FIG. 1C, the terminals are connected to undersea optical communication systems, although those skilled in the art will readily appreciate that the present invention is equally applicable to devices which operate in terrestrial communication systems.

As shown in FIG. 1C, the long reach transmitters/receivers (LRTRs) 30 convert terrestrial signals into an optical format for long haul transmission, convert the undersea optical signal back into its original terrestrial format and provide forward error correction. The number of LRTRs 30 in each terminal will vary with the number of channels supported by the optical communication system, but may easily reach 100, 200, 300 or more per terminal. Each LRTR 30 can include a laser and a modulator, for example, and can be provided on one or more line cards which are physically mounted in shelves as described below.

A WDM and optical conditioning unit 32 multiplexes and amplifies the optical signals in preparation for their transmission over cable 34 and, in the opposite direction, demultiplexes optical signals received from cable 34. Link monitor equipment 36 monitors the optical signals and undersea equipment for proper operation. Line current equipment 38 provides power to undersea line units. A network management system (NMS) 40 controls the operation of the other components in the WDM terminal, as well as sending commands to the line units via the link monitor equipment 36, and is connected to the other components in the WDM terminal via a backplane 42. The fiber handling track 10 can be included in the WDM terminal to control the optical fibers interconnecting the different parts of the terminal, such as the optical fibers to and from the LRTRs 30.

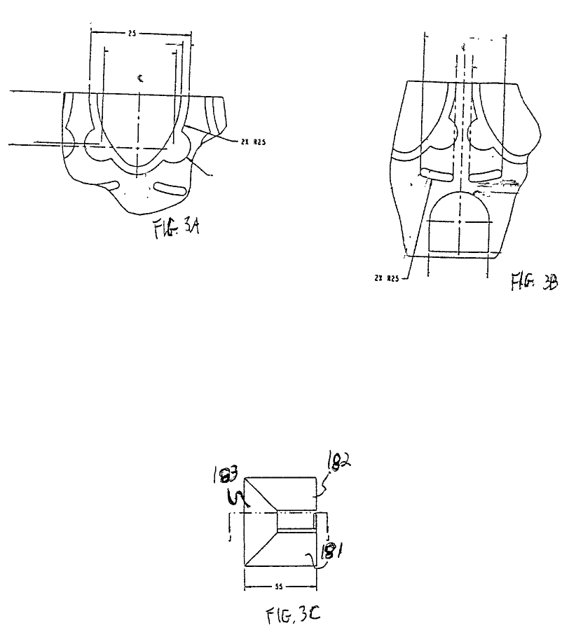

FIG. 2A is a front view of the fiber handling track 10 of FIG. 1A. As shown in FIG. 2A, each of the radius control bosses 12 includes a pair of control boss tabs 28. Each one of the pair of control boss tabs 28 is located on opposing sides of the respective radius control boss 12 and is located at the front edge of the fiber handling track 10. The shape of the control boss tabs 28 is shown as semi-circular in FIG. 1A, although other shapes may be used. Regardless of the shape, the control boss tabs 28 are preferably designed to help retain the optical fibers received by the radius control bosses 12 inside the fiber handling track 10.

The number of radius control bosses 12 shown in FIG. 2A is seventeen, although this number may be different for different implementations depending upon the number of circuit boards in a subrack of the communication equipment in which the fiber handling track 10 is installed. Of the seventeen radius control bosses 12, sixteen of the radius control bosses 12 may receive optical fibers from active circuit boards, while the remaining radius control boss 12 receives optical fibers from redundant circuit boards. As the fiber retention tabs 16 are located approximately in between respective pairs of the radius control bosses 12, the number of fiber retention tabs is one fewer than the number of radius control bosses 12, or sixteen as shown in FIG. 2A.

FIG. 2B is a back view of the fiber handling track 10 of FIG. 1A. As shown in FIG. 2B, the back side of the fiber handling track 10 includes sixteen break through portions 24 and seventeen pairs of break through portions 26. The number of break through portions 24 corresponds to the number of fiber retention tabs 16, and the number of break through portions 26 corresponds to the number of pairs of control boss tabs 28.

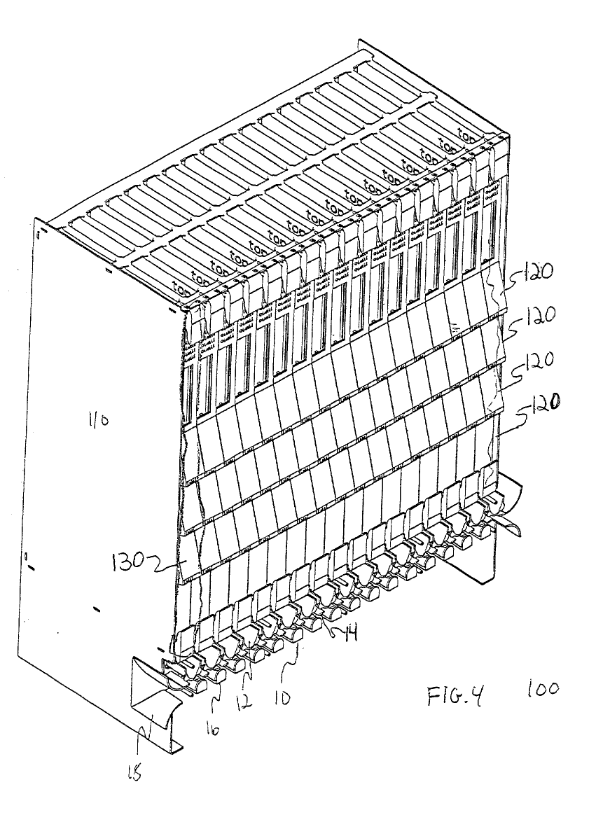

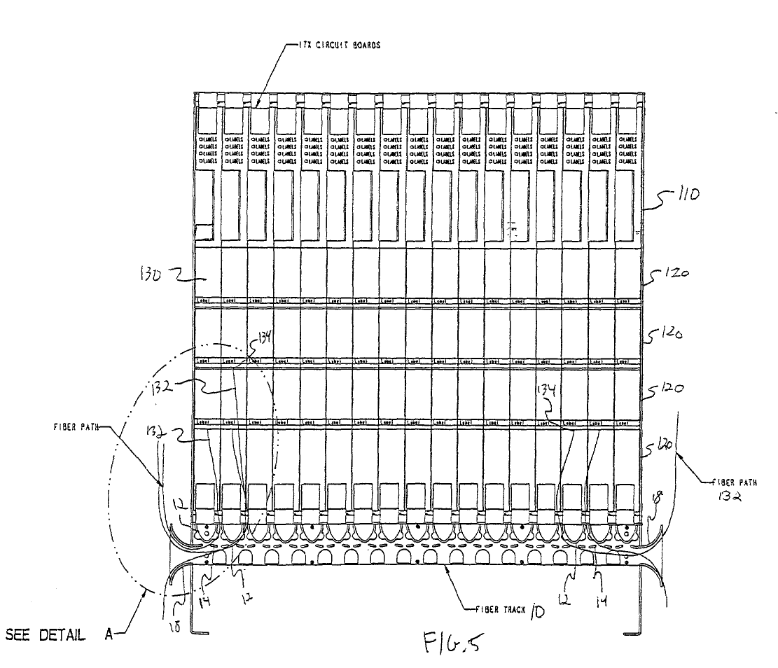

FIG. 3A is a detail view along the A-section of the fiber handling track 10 of FIG. 2A. The view shown in FIG. 3A shows a detailed illustration of a radius control boss 12. FIG. 3B is a detail view along the B-section of the fiber handling track 10 of FIG. 2A. The view shown in FIG. 3B shows a detailed illustration of a pair of radius control tabs 14 and the tongue portion of a fiber retention tab 16. FIG. 3C is a plan view of the bell flare 18 of the fiber handling track 10 of FIG. 1A. As shown in FIG. 3C, the bell flare 18 includes three flared portions 181, 182 and 183. The radius control boss 12, radius control tabs 14 and the bell flare 18 are each designed to ensure that the optical fiber does not bend beyond a minimum bend radius, such as 25 mm.

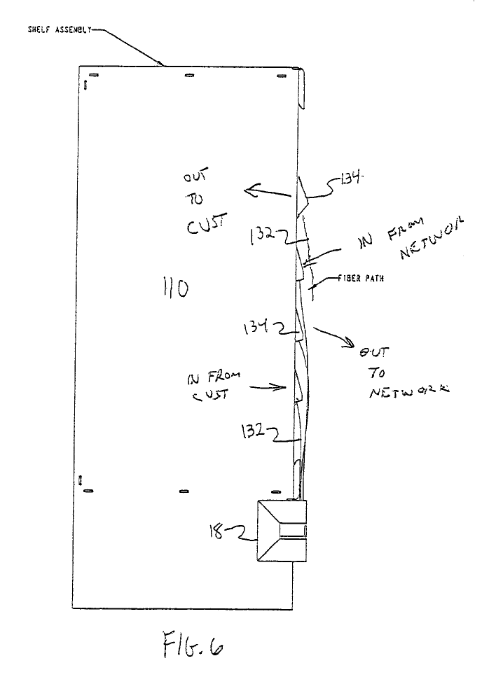

FIG. 4 is an isometric view of an equipment rack including the fiber handling track 10 of FIG. 1A. As shown in FIG. 4, an equipment rack 100 includes a cabinet 110 and a plurality of subracks 120. Each subrack 120 includes a plurality of circuit cards 130. The equipment rack 100 also includes the fiber handling track 10 below the subracks 120. In an alternative arrangement, the fiber handling track 10 could be located above the subracks 120.

In the equipment rack 100 shown in FIG. 4, there are four subracks 120, each holding seventeen circuit cards 130. The number of subracks 120 and the number of circuit cards 130 may vary depending on a variety of factors, such as the capacity requirements of the communication system in which the equipment rack 100 is being implemented and the amount of redundancy used. For example, as described above, of the seventeen circuit cards 130, one may be a redundant circuit card 130. Each subrack 120 is arranged in parallel on top of the other in a substantially horizontal direction. The circuit cards 130 are each arranged in parallel to each other in a substantially vertical direction, or more generally, in a direction substantially perpendicular to the direction of the subrack 120.

FIG. 5 is a front view of the equipment rack 100 of FIG. 4. As shown in FIG. 5, some of the circuit cards 130 are shown with an optical fiber 132 output from a port 134. The optical fibers 132 output from each port 134 drop down in a substantially vertical direction from the corresponding circuit card 130 and is received by a respective one of the radius control bosses 12 of the fiber handling track 10. The radius control boss 12 diverts the received one or more optical fibers 132 from the substantially vertical direction to a substantially horizontal direction, or more generally, a direction substantially perpendicular to the direction in which the optical fibers 132 are received. As shown in FIG. 5, the optical fibers 132 can be diverted to the left side or the right side of the cabinet 110. The optical fibers 132 diverted by the radius control bosses 12 are further guided in the substantially horizontal direction by the radius control tabs 14.

At each end of the fiber handling track 10, the optical fibers 132 are received by the bell flares 18. Each bell flare 18 diverts the received optical fibers 132 from the substantially horizontal direction to a substantially vertical direction, or more generally, to a direction substantially perpendicular to the direction in which the optical fibers 132 are received by the bell flares 18. As shown in FIG. 5, the optical fibers 132 diverted by the bell flares 18 can be diverted up the side of the cabinet 110 or down the side of the cabinet 110 toward the floor. In addition, the bell flares 18 can divert the received optical fibers 132 in a substantially horizontal direction, but perpendicular to the direction in which they are received, along the side of the cabinet 110 and toward the back of the cabinet 110. From the bell flares 18, the optical fibers 132 can be provided to another equipment rack 100, to customer equipment or to other network equipment.

As described above, the optical fibers 132 are received by the fiber handling track 10 and diverted to other equipment. In addition, this handling of the optical fibers 132 can work in reverse. In particular, the fiber handling track 10 can receive optical fibers 132 from other equipment and divert it to circuit cards 130 within the equipment rack 100.

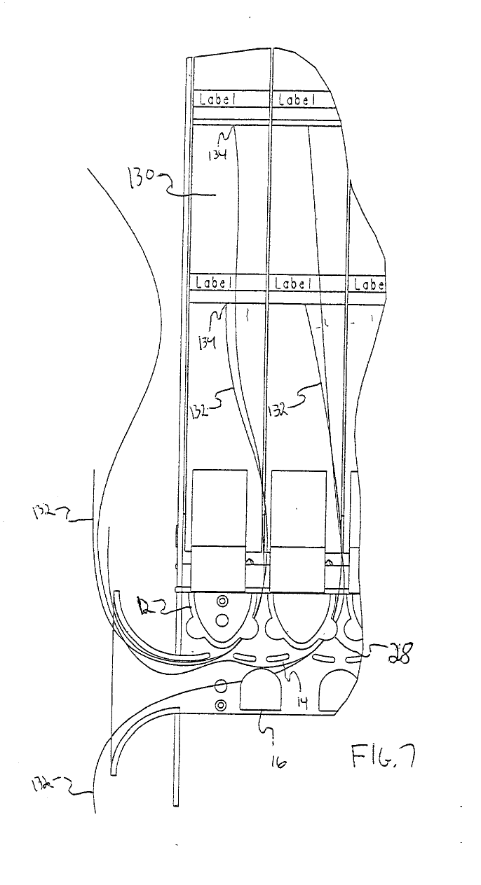

FIG. 6 is a side view of the equipment rack 100 of FIG. 4. As shown in FIG. 6, four ports 134 are shown, each port 134 receives or outputs a fiber 132. The fibers 132 can be output to customer equipment or input from customer equipment. In addition, the fibers 132 can be out to network equipment, such as another equipment rack 100, or input from network equipment.

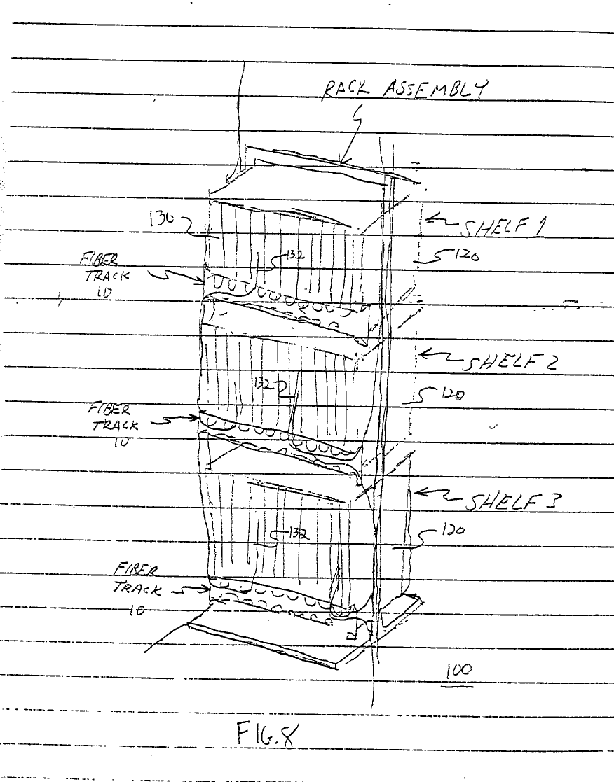

FIG. 7 is a detail view along the A-section of the equipment rack 100 of FIG. 5 showing in detail the interaction of the optical fibers 132 with the fiber handling track 10. As shown in FIG. 7, the optical fibers 132 output from the ports 134 of the circuit cards 130 are received by the radius control bosses 12. The radius control bosses 12 divert the optical fibers 132, and the control boss tabs 28 retain the optical fibers received by the radius control bosses 12 inside the fiber handling track 10.

Except for the radius control boss 12 located adjacent to the bell flare 18, each optical fiber diverted by the radius control bosses 12 is guided further by the radius control tabs 14. As described above, the radius control bosses 12 and the radius control tabs 14 ensure that the optical fibers 132 to do not bend beyond a minimum bend radius. The optical fibers 132 diverted by the radius control bosses 12 are diverted by the bell flare 18 either up or down the side of the cabinet 110. Although not shown, the bell flare 18 can also divert the optical fibers 132 along the side toward the back of the cabinet 110.

In the equipment rack 100 shown in FIGS. 4-6, the equipment rack 100 includes multiple subracks 120 and a single fiber handling track 10. The equipment rack 100 can also have alternative arrangements. For example, as described above, the position of the fiber handling track 10 with respect to the subracks 120, as well as the number of subracks 120 and fiber handling tracks 10 in the equipment rack 100 can be different.

FIG. 8 is an isometric view of an equipment rack 100 with multiple subracks and fiber handling tracks consistent with the present invention. As shown in FIG. 8, the equipment rack 100 includes three subracks 120 and three fiber handling tracks 10. Each fiber handling track 10 is located below a respective one of the subracks 120. In this design, there are fewer optical fibers 132 that are handled by each fiber handling track 10, which can make the handling of the optical fibers 132 less cumbersome and the maintenance of the equipment easier.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. An equipment rack, comprising:
a subrack mounted in a first direction in the equipment rack;
one or more circuit cards, each circuit card being mounted in the subrack in a second direction substantially perpendicular to the first direction and in parallel with each other circuit card mounted in the subrack, each circuit card including one or more ports coupled to a respective optical fiber traveling in the second direction; and
a fiber handling track mounted in the first direction in the equipment rack, the fiber handling track comprising:
one or more radius control bosses, the number of radius control bosses equaling or exceeding the number of circuit cards mounted in the subrack, each of the radius control bosses adapted to receive an optical fiber coupled to a respective one of the one or more circuit cards and divert the received optical fiber from the second direction to the first direction; and
a bell flare located at one end of the fiber handling track, the bell flare adapted to receive the optical fibers diverted by the one or more radius control bosses and divert the received optical fibers from the first direction to a third direction substantially perpendicular to the first direction.

2. An equipment rack according to claim 1,
wherein each of the one or more radius control bosses restricts the bending of the received optical fiber from bending more than a minimum bend radius.

3. An equipment rack according to claim 2,
wherein each of the one or more radius control bosses restricts the bending of the received optical fiber to at least a radius of 25 mm.

4. An equipment rack according to claim 1,
wherein the bell flare restricts the bending of the received one or more optical fibers from bending more than a minimum bend radius.

5. An equipment rack according to claim 4,
wherein each of the one or more radius control bosses restricts the bending of the received optical fiber to at least a radius of 25 mm.

6. An equipment rack according to claim 1, wherein the fiber handling track further comprises:
a plurality of radius control tabs, each pair of radius control tabs being spaced away from and located between adjacent pairs of radius control bosses, the radius control tabs further restricting the bending of the optical fibers diverted by the radius control bosses.

7. An equipment rack according to claim 1, wherein the fiber handling track further comprises:
a second bell flare mounted at the other end of fiber handling track, the second bell flare receiving at least one of the optical fibers diverted by the one or more radius control bosses and diverting the received at least one of the optical fibers from the first direction to the third direction.

8. An equipment rack according to claim 1, wherein the radius control bosses are located along a first side of the fiber handling track, and the fiber handling track further comprises:
fiber retention tabs located along a second side of the fiber handling track opposite the first side, the fiber retention tabs retaining the optical fibers diverted by the radius control tabs within the fiber handling track.

9. An equipment rack according to claim 1, wherein the fiber handling track further comprises:
a plurality of cover bosses; and
a plate coupled to the cover bosses, the plate retaining the optical fibers within the fiber handling track.

10. An equipment rack according to claim 1, further comprising:
at least one or more additional subracks mounted in the first direction of the equipment rack, each additional subrack having one or more circuit cards, each circuit card being mounted in the additional subrack in the second direction and in parallel with each other circuit card mounted in the additional subrack, each circuit card including a port coupled to an optical fiber traveling in the second direction,
wherein each of the radius control bosses is adapted to receive an optical fiber coupled to a respective one of the one or more circuit cards in a respective one of the at least one additional subracks and to divert the received optical fiber from the second direction to the first direction.

11. An equipment rack according to claim 1,
wherein the bell flare includes at least two flared portions, each flared portion being shaped to divert the received optical fibers from the first direction to the third direction and to restrict the bending of the received optical fibers from bending more than a minimum bend radius.

12. A fiber handling track, comprising:
one or more radius control bosses, each of the radius control bosses adapted to receive in a first direction an optical fiber coupled to at least one of one or more circuit cards and divert the received optical fiber from the first direction to a second direction substantially perpendicular to the first direction; and
a bell flare located at one end of the fiber handling track, the bell flare adapted to receive the optical fibers diverted by the one or more radius control bosses and divert the received optical fibers from the second direction to a third direction substantially perpendicular to the second direction.

13. A fiber handling track according to claim 12,
wherein each of the one or more radius control bosses restricts the bending of the received optical fiber from bending more than a minimum bend radius.

14. A fiber handling track according to claim 13,
wherein each of the one or more radius control bosses restricts the bending of the received optical fiber to at least a radius of 25 mm.

15. A fiber handling track according to claim 12,
wherein the bell flare restricts the bending of the received one or more optical fibers from bending more than a minimum bend radius.

16. A fiber handling track according to claim 15,
wherein each of the one or more radius control bosses restricts the bending of the received optical fiber to at least a radius of 25 mm.

17. A fiber handling track according to claim 12, wherein the fiber handling track further comprises:
a plurality of radius control tabs, each pair of radius control tabs being spaced away from and located between adjacent pairs of radius control bosses, the radius control tabs further restricting the bending of the optical fibers diverted by the radius control bosses.

18. A fiber handling track according to claim 12, wherein the fiber handling track further comprises:
a second bell flare mounted at the other end of fiber handling track, the second bell flare receiving at least one of the optical fibers diverted by the one or more radius control bosses and diverting the received at least one of the optical fibers from the second direction to the third direction.

19. A fiber handling track according to claim 12,
wherein the radius control bosses are located along a first side of the fiber handling track, and the fiber handling track further comprises:
fiber retention tabs located along a second side of the fiber handling track opposite the first side, the fiber retention tabs retaining the optical fibers diverted by the radius control tabs within the fiber handling track.

20. A fiber handling track according to claim 12, wherein the fiber handling track further comprises:
a plurality of cover bosses; and
a plate coupled to the cover bosses, the plate retaining the optical fibers within the fiber handling track.

21. A fiber handling track according to claim 12,
wherein the bell flare includes at least two flared portions, each flared portion being shaped to divert the received optical fibers from the second direction to the third direction and to restrict the bending of the received optical fibers from bending more than a minimum bend radius.

22. A terminal unit comprising:
a plurality of optical transceivers for transmitting and receiving WDM signals over optical fibers; and
a fiber handling track for routing said optical fibers to and from said plurality of optical transceivers, said fiber handling track including:
one or more radius control bosses, each of the radius control bosses adapted to receive in a first direction an optical fiber coupled to at least one of the plurality of optical transceivers and divert the received optical fiber from the first direction to a second direction substantially perpendicular to the first direction; and
a bell flare located at one end of the fiber handling track, the bell flare adapted to receive the optical fibers diverted by the one or more radius control bosses and divert the received optical fibers from the second direction to a third direction substantially perpendicular to the second direction.

23. A terminal unit according to claim 22,
wherein each of the one or more radius control bosses restricts the bending of the received optical fiber from bending more than a minimum bend radius.

24. A terminal unit according to claim 23,
wherein each of the one or more radius control bosses restricts the bending of the received optical fiber to at least a radius of 25 mm.

25. A terminal unit according to claim 22,
wherein the bell flare restricts the bending of the received one or more optical fibers from bending more than a minimum bend radius.

26. A terminal unit according to claim 25,
wherein each of the one or more radius control bosses restricts the bending of the received optical fiber to at least a radius of 25 mm.

27. A terminal unit according to claim 22, wherein the fiber handling track further comprises:
a plurality of radius control tabs, each pair of radius control tabs being spaced away from and located between adjacent pairs of radius control bosses, the radius control tabs further restricting the bending of the optical fibers diverted by the radius control bosses.

28. A terminal unit according to claim 22, wherein the fiber handling track further comprises:
a second bell flare mounted at the other end of fiber handling track, the second bell flare receiving at least one of the optical fibers diverted by the one or more radius control bosses and diverting the received at least one of the optical fibers from the second direction to the third direction.

29. A terminal unit according to claim 22,
wherein the radius control bosses are located along a first side of the fiber handling track, and the fiber handling track further comprises:
fiber retention tabs located along a second side of the fiber handling track opposite the first side, the fiber retention tabs retaining the optical fibers diverted by the radius control tabs within the fiber handling track.

30. A terminal unit according to claim 22, wherein the fiber handling track further comprises:
a plurality of cover bosses; and
a plate coupled to the cover bosses, the plate retaining the optical fibers within the fiber handling track.

31. A terminal unit according to claim 22,
wherein the bell flare includes at least two flared portions, each flared portion being shaped to divert the received optical fibers from the second direction to the third direction and to restrict the bending of the received optical fibers from bending more than a minimum bend radius.
